(19) United States
(12) Patent Application Publication
(10) Pub. No.: US 2018/0059890 A1
(43) Pub. Date: Mar. 1, 2018

(54) INFORMATION PROCESSING APPARATUS, INFORMATION PROCESSING METHOD, AND STORAGE MEDIUM STORING PROGRAM

(71) Applicant: CANON KABUSHIKI KAISHA, Tokyo (JP)

(72) Inventor: Satoko Saito, Kawasaki-shi (JP)

(21) Appl. No.: 15/681,548

(22) Filed: Aug. 21, 2017

(30) Foreign Application Priority Data
Aug. 29, 2016 (JP) 2016-167139

(51) Int. Cl. G06F 3/0483; G06F 3/0482; G06F 3/0488

(52) U.S. Cl. CPC G06F 3/0483; G06F 3/04886; G06F 3/0482

(57) ABSTRACT

An information processing apparatus including: a processor; and a memory storing a program which, when executed by the processor, causes the information processing apparatus to: display, on a screen at a first display magnification, a part of an area of a page in which a plurality of objects are arranged; accept an operation for changing an object to be selected among the plurality of objects when the part of the area of the page is displayed in the screen at the first display magnification; and display the entire page including the changed object to be selected at a second display magnification that is less than the first display magnification when the object to be selected is changed.

### BACKGROUND OF THE INVENTION

### Field of the Invention

The present disclosure relates to an information processing apparatus, an information processing method, and a storage medium that stores a program therein.

### Description of the Related Art

An information processing apparatus in which a user arranges an image and enters a text and thereby a document is generated has been proposed. A document is formed of a plurality of pages, and such an information processing apparatus manages a content of an image or a text displayed in each page, page layout information, or the like. Such an information processing apparatus can use the page layout information and arrange the image or the text in a page. Further, such an information processing apparatus can display a plurality of pages in a spread and provide a preview in a bookbinding state. Further, such an information processing apparatus can zoom in and out a preview image, which allows a user to proceed editing work of the text while reviewing the whole and details as appropriate. Further, in such an information processing apparatus, it is possible to switch an object to be edited by a user operation.

Further, Japanese Patent Application Laid-Open No. 2014-106596 proposes an information processing apparatus that displays a preview of a plurality of pages in a spread and also displays, at a predetermined position of a display area, text information associated with a page which is being displayed in the preview.

In the conventional information processing apparatus, however, it may not be easy for a use to know which text of the plurality of texts included in a page is to be edited.

### SUMMARY OF THE INVENTION

According to an aspect of an embodiment, there is provided an information processing apparatus comprising: a processor; and a memory storing a program which, when executed by the processor, causes the information processing apparatus to: display, on a screen at a first display magnification, a part of an area of a page in which a plurality of objects are arranged; accept an operation for changing an object to be selected among the plurality of objects when the part of the area of the page is displayed in the screen at the first display magnification; and display the entire page including the changed object to be selected at a second display magnification that is less than the first display magnification when the object to be selected is changed.

According to another aspect of an embodiment, there is provided an information processing method comprising steps of: displaying, on a screen at a first display magnification, a part of an area of a page in which a plurality of objects are arranged; accepting an operation for changing an object to be selected among the plurality of objects, when the part of the area of the page is displayed at the first display magnification; and displaying the entire page including the changed object to be selected at a second display magnification that is less than the first display magnification when the object to be selected is changed.

According to further another aspect of an embodiment, there is provided a non-transitory computer-readable storage medium storing a program that, when executed by a processor, cause the processor to perform operations comprising: displaying, on a screen at a first display magnification, a part of an area of a page in which a plurality of objects are arranged; accepting an operation for changing an object to be selected among the plurality of objects when the part of the area of the page is displayed at the first display magnification; and displaying the entire page including the changed object to be selected at a second display magnification that is less than the first display magnification when the object to be selected is changed.

Further features of the present invention will become apparent from the following description of exemplary embodiments with reference to the attached drawings.

### BRIEF DESCRIPTION OF THE DRAWINGS

FIG. 1 is a block diagram illustrating an information processing apparatus according to an embodiment.

FIG. 2 is a diagram illustrating an example of as edit screen is the information processing apparatus according to an embodiment.

FIG. 3 is a diagram illustrating an example of an edit screen in the information processing apparatus according to an embodiment.

FIG. 4 is a flowchart illustrating operation of the information processing apparatus according to an embodiment.

FIG. 5A, FIG. 5B, FIG. 5C, and FIG. 5D are diagrams illustrating examples of tables used in the information processing apparatus according to an embodiment.

FIG. 6 is a flowchart illustrating operation of the information processing apparatus according to an embodiment.

### DESCRIPTION OF THE EMBODIMENTS

Preferred embodiments of the present invention will now be described in detail is accordance with the accompanying drawings. Note that the present invention is not limited to the following embodiments and can be changed as appropriate within a scope not departing from its spirit. For example, the present invention may be modified or changed as appropriate in accordance with the configuration or various conditions of the apparatus to which the present invention is applied.

### One Embodiment

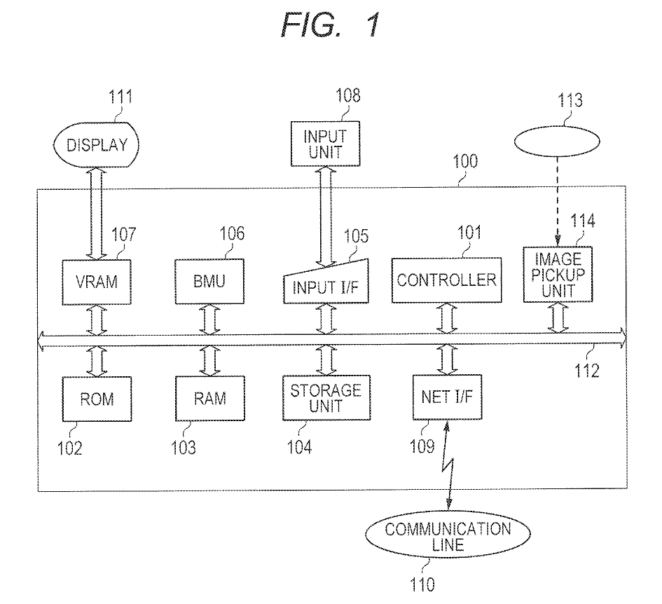

An information processing apparatus, an information processing method, and a program according to an embodiment will be described with reference to FIG. 1. FIG. 1 is a block diagram illustrating an information processing apparatus according to an embodiment. While a case where an information processing apparatus 100 according to the present embodiment is a smartphone that is an electronic device having both the function of a personal computer or a mobile information terminal and the function of a mobile phone will be described here as an example, the information processing apparatus 100 is not limited thereto. The information processing apparatus 100 may be a tablet terminal, a personal computer (PC), a personal digital assistant (PDA), a mobile phone, or the like, for example. Further, the information processing apparatus 100 may be an image viewer, a digital camera, a printer, a digital photo frame, a music player, a game machine, an electronic book reader, or the like. That is, the present invention can be widely applied to electronic devices that can perform display on a display screen. Further, a case of determining a layout of a book (photo book) will be described here as an example, the present invention is not limited thereto.

A controller 101 is a central processing unit (CPU), for example, and manages the entire control of the information processing apparatus 100 of the present embodiment. A controller 101 may be implemented by a single CPU, or distributed processing may be performed by a plurality of CPUs. A read only memory (ROM) 102 stores a program or parameters therein that do not require a change. A random access memory (RAM) 103 temporarily stores a program or data supplied from an external device or the like. A storage unit 104 stores an operating system (OS), an application program, or the like. An application program may be a book generation application program or the like that is an application program that generates a book, for example. A case of using a book generation application program to generate a book will be described here as an example. The information processing apparatus 100 according to the present embodiment can use an image pickup unit 114 to acquire an optical image formed by using image pickup optics (lens) 113. An image (image file) acquired by the image pickup unit 114 is stored in the storage unit 104. For example, an electrically rewritable non-volatile memory or the like is used for the storage unit 104. Such a non-volatile memory may be a flash memory (registered trademark) or the like, for example. Note that the storage unit 104 is not limited to a flash memory and may be a hard disk drive or the like, for example.

An input unit 108 is connected to an input interface (input I/F) 105. A user may perform various operations, data entry, or the like on the information processing apparatus 100 via the input unit 108. A bit move unit (BMU) 106 controls data transfer between memories or data transfer between a memory and an I/O device, for example. Data transfer between memories may be data transfer between a video random access memory (RAM) 107 and the RAM 103 or the like, for example. Data transfer between a memory and an I/O device may be data transfer between the VRAM 107 and the network interface (NET I/F) 109 or the like, for example. The VRAM 107 generates an image to be displayed on a display 111. The image generated by the VRAM 107 is transmitted to the display 111 according to a predetermined specification, and thereby the display 111 displays an image. The network interface 109 connects the information processing apparatus 100 to a network line 110 such as the Internet. A system bus 112 connects respective components such as the controller 101, the ROM 102, the RAM 103, the storage unit 104, or the like provided in the information processing apparatus 100 to each other in a communicable manner.

The display 111 and the input unit 108 can be formed of a touch panel, for example. A touch panel is an electronic component in which a display device and an input device are combined and attached in a planar manner. A user can input an operation by touching a display screen of the touch panel by the finger or a dedicated pen. For example, a liquid crystal panel, an organic EL panel, or the like is used as such a display device. For example, a touch sensor or the like is used as such an input device. The display 111 corresponds to the display device included in the touch panel. The input unit 108 corresponds to the input device included in the touch panel. Information on positional coordinates in accordance with a contact position of the finger or the pen is input from the input unit 108 via the input interface 105. A case where the input unit 108 is formed of the input device of the touch panel is described here as an example, the input unit 108 is not limited thereto. The input unit 108 may be formed of both of the input device of the touch panel and operation buttons or the like. Note that the scheme of the touch panel may be any of various schemes such as a resistive film scheme, a static capacitance scheme, a surface acoustic wave scheme, an infrared ray scheme, an electromagnetic guide scheme, an image recognition scheme, an optical sensor scheme, or the like.

The controller 101 can detect the following operation to a touch panel, for example. That is, the controller 101 can detect that the touch panel has been contacted with a finger or a pen (hereafter, referred to as “touchdown”). Further the controller 101 can detect that the touch panel is in contact with a finger or a pen (hereafter, referred to as “touch-on”). Further, the controller 101 can detect that, with the touch panel being in contact with a finger or a pen, the finger or the pen is moving on the touch panel (hereafter, referred to as “move”). Further, the controller 101 can detect that a finger or a pen which has been contacted with the touch panel is detached from the touch panel (hereafter, referred to as “touchup”). Further, the controller 101 can detect that a finger, a pen, or the like is not in contact with the touch panel (hereafter, referred to as “touch-off”).

Such an operation is called “tap” that a touch-on is detected immediately after detection of a touchdown, the time period during which the touch-on continuously detected is shorter than a predetermined time period, and no other touch operation is detected within a predetermined time period before and after the touchdown. Such an operation that tap is made twice within a predetermined time period is called “double tap”. Further, an operation of quickly moving a finger or a pen on the touch panel with a finger or a pen being in contact with the touch panel and detaching the finger or the pen from the touch panel is called “flick”. Further, an operation of sliding a finger or a pen on the touch panel with a finger or a pen being in contact with the touch panel is called “swipe”. Further, an operation of moving two fingers on the touch panel with the fingers being in contact with the touch panel so as to reduce the distance between two points where the fingers are in contact is called “pinch-in”. Further, an operation of moving two fingers on the touch panel with the finger being in contact with the touch panel so as to increase the distance between two points where the fingers are in contact is called “pinch-out”.

The controller 101 is notified of information on positional coordinates indicating a contact position of a finger or a pen in contact with the touch panel. Based on information of the positional coordinates notified from the touch panel, the controller 101 determines what operation is performed on the touch panel by a user. When a move is performed, the controller 101 can determine a moving direction of a finger or a pen moving on the touch panel based on a change of the positional coordinates in the vertical direction and a change or the positional coordinates in the horizontal direction. When, after a touchdown, a move of a predetermined distance or longer is performed and a touchup is then performed, the controller 101 determines that a drop is performed after a drag, that is, a drag-and-drop is performed.

When distributed processing by a plurality of CPUs is performed in the controller 101, information on the positional coordinates issued from the touch panel is acquired by one of the CPUs included in the controller 101. The one of the CPUs determines what operation is performed on the touch panel by a user based on the information of the positional coordinates. The one of the CPUs issues various events indicating what operation is performed by a user. The other CPUs included in the controller 101 control the information processing apparatus 100 of the present embodiment based on the various events issued from the one of the CPUs.

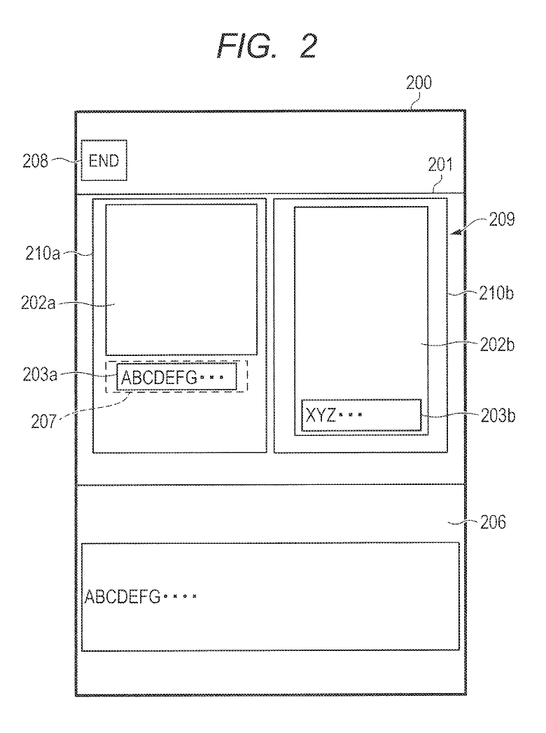

The operation of the information processing apparatus 100 according to the present embodiment will be described by using the drawings. FIG. 2 is a diagram illustrating an example of an edit screen in the information processing apparatus according to the present embodiment. FIG. 2 illustrates a state where a book is displayed in a preview area.

A preview area 201 for displaying a preview of pages 210a and 210b to be edited is set in a part of the edit screen 200. A book 209 is displayed in a spread in the preview area 201 such that the opened entire book (photo book) 209 can be reviewed. In such a way, a display in a manner that the entire page of the book 209 is displayed is called “normal display”. In the normal display, the entire page consisting of the pages 210a and 210b to be edited is displayed within the preview area 201. On a page of the book 209 displayed in the preview area 201, a user can move a page to another page by an operation of flick or the like and can change the display magnification by an operation of a pinch-in or a pinch-out. In the default edit screen 200, a page of the book 209 is displayed such that the entire page of the spread book 209 is displayed within the preview area 201 at a predetermined display magnification, that is, at a default display magnification. In other words, a page of the book 209 is displayed at a display magnification of 100%. The book 209 has a plurality of pages. FIG. 2 illustrates a spread page including one page 210a of the plurality of pages and the page 210b next to the page 210a. Note that the reference numeral 210 will be used in the general description of a page included in the book 209. In the page 210a illustrated in the left side in FIG. 2, an image area 202a and a text area 203a are arranged. In the page 210b illustrated in the right side in FIG. 2, an image area 202b and a text area 203b are arranged. Note that the reference numeral 202 is used in the general description of an image area, and the reference numeral 203 is used in the general description of a text area.

A first image is displayed in the image area 202a, for example, and a first text is displayed in the text area 203a, for example. Description will be provided here as the content of the first text being “ABCDEFG . . . ”. A second image is displayed in the image area 202b, for example, and a second text is displayed in the text area 203b, for example. Description will be provided here as the content of the second text being “XYZ . . . ”. The image areas 202 and the text areas 203 are set according to a layout of a design template provided in a book generation application program.

For example, under the preview area 201 of the edit screen 200, a text edit area 206 for editing the content of the text of the text area (object) 203 to be edited is set. A mark 207 is provided to the text area 203 to be edited. The mark 207 is for making the text area 203 to be edited identifiable. Based on which of the text area 203 the mark 207 is provided to, a user can recognize which of and whether or not the text area 203 is to be edited FIG. 2 illustrates a state where the text area 203a is to be edited. The text area 203 to be edited can be moved by a user performing a flick operation or the like on the text edit area 206. Note that the text area 203 to be edited may be changed by a user operation on an operation button Such an operation button forms a part of the input unit 108.

An end button 208 for closing editing of the book 209 is arranged in the left upper part of the edit screen 200, for example. The user can close editing of the book 209 by pressing the end button 208.

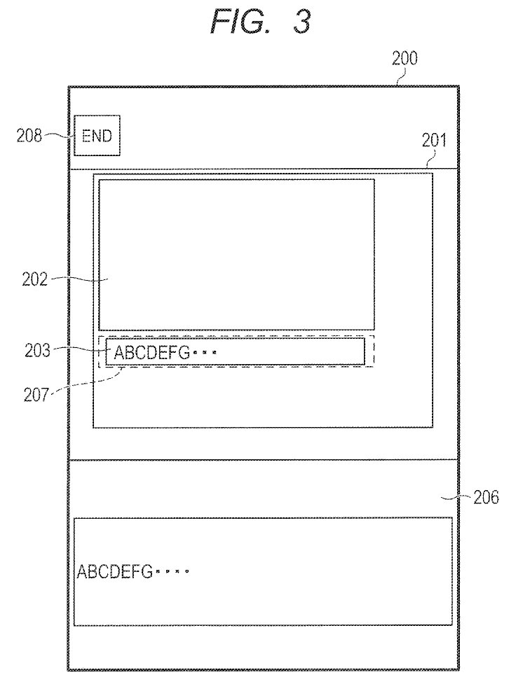

FIG. 3 is a diagram illustrating another example of the edit screen 200. FIG. 3 illustrates a state where a part of the page of the book 209 is zoomed-in and displayed within the preview area 201. In FIG. 3, a part of the image area 202 and the text area 203 are displayed within the preview area 201. The user can review in detail the arrangement of an image, a text, or the like by observing the image area 202 or the text area 203 in the zoomed-in display. A portion displayed within the preview area 201 of the page of the book 209 can be moved by an operation such as a swipe. In FIG. 3, the image area 202b and the text area 203b located in the right page 210b of the spread book 209 (see FIG. 2) are not displayed within the preview area 201. However, a user operation such as a swipe allows, instead of the left page 210a of a spread book 209, the image area 202b and the text area 203b located in the right page 210b to be displayed within the preview area 201.

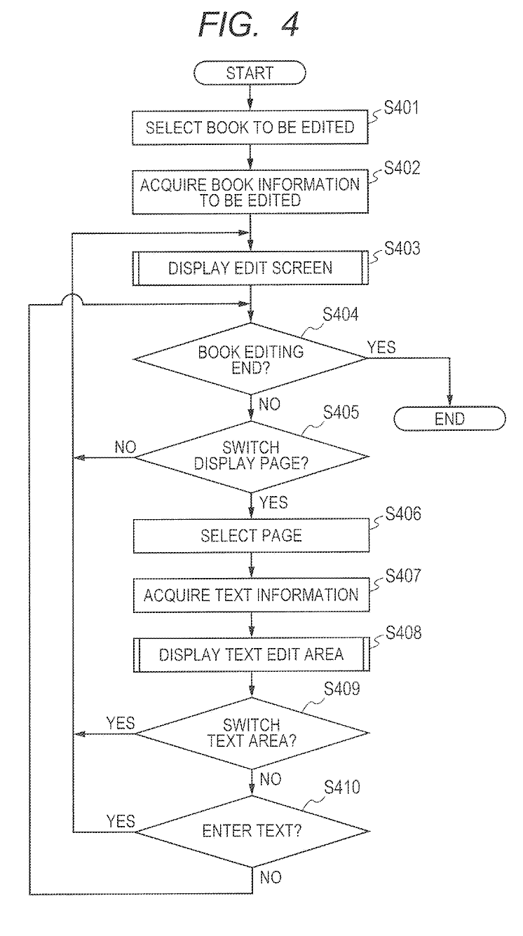

FIG. 4 is a flowchart illustrating the operation of the information processing apparatus 100 according to the present embodiment. At step S401, the book 209 to be edited is selected. When the existing books 209 are stored in a book database (book DB), the controller 101 displays a list of the existing books 209 stored in the book database and also displays a new book 209. The user can select the book 209 to be edited out of the listed books 209 by performing an operation such as a double-tap. Further, the user can select the new book 209 as a book to be edited. Note that the book database is provided within the storage unit 104, for example.

At step S402, the controller 101 acquires information on the book 209 to be edited, that is, book information from the book database. When the book 209 to be edited is the new book, the controller 101 issues the book ID to the new book 209. Such a hook ID forms a part of the book information. When the new book 209 is selected and no particular editing work has been performed on the new book 209, the book information on the new book 209 is blank except the book ID. Note that a case where the existing book 209 is to be edited will be described below as an example.

At step S403, the controller 101 displays the edit screen 200 on a display screen of the display 111. While no operation for changing the display magnification is performed, the controller 101 displays a page of the book 209 to be edited at a default display magnification in the preview area 201 of the edit screen 200. The controller 101 sets the image area 202 and the text area 203 within the preview area 201 based on the layout information of the page of the book 209 to be edited. Further, the controller 101 reads out, from the storage unit 104, a thumbnail image used for the page of the book 209 to be edited and displays the read out thumbnail image in the image area 202. Note that file paths of the thumbnail images are stored in the book database. Based on the file path of the thumbnail image included in the book database, the controller 101 reads out, from the storage unit 104, the thumbnail image used for the page of the book 209 to be edited. Further, text information is stored in the book database. The controller 101 uses the text information included in the book database to display a text in the text area 203. The controller 101 provides the mark 207 to the text area 203 to be edited. For example, in the default state, the text area 203 present within the page 210 located in the left side of the two pages 210 displayed in the preview area 201 is to be edited. When a plurality of text areas 203 are present within the page 210, the head text area 203 of the plurality of areas 203 is to be edited. Further, the controller 101 sets the text edit area 206 in a predetermined position within the edit screen 200 and, in the text edit area 206, displays the content of the text written in the text area 203 to be edited. In such a way, the controller 101 can function as a controller configured to perform control such that the page 210 in which the text area 203 is set is displayed on the preview area 201 of the edit screen 200, that is, a predetermined area.

When an operation such as a pinch-in for reducing the display magnification is performed by the user, the controller 101 zooms out and displays the page of the book 209 to a degree in accordance with an operating amount in the pinch-in or the like. When an operation such as a pinch-out for increasing the display magnification is performed by the user, the controller 101 zooms in and displays the page of the book 209 to a degree in accordance with an operating amount in the pinch-out or the like. The user can review in detail the arrangement of an image or a text by observing the image area 202 or the text area 203 which has been zoomed in (see FIG. 3).

Note that, while a case where the display magnification is changed by an operation such as a pinch-in or a pinch-out has been described here as an example, the way of changing the display magnification is not limited thereto. For example, a slider bar may be arranged in the edit screen 200, and the display magnification may be changed by a user operation on the slider bar. Further, a zoom-out button or a zoom-in button may be arranged in the edit screen 200, and the display magnification may be changed by a user operation on the zoom-out button or the zoom-in button. Further, a key may be arranged in the information processing apparatus 100, and the display magnification may be changed by a user operation to the key.

At step S404, when the end button 208 for closing the editing of the book 209 is pressed by the user (step S404, YES), the controller 101 closes the edit of the book 209. When the end button for closing edit of the book 209 is not pressed by the user (step S404, NO), step S405 is entered.

When an operation such as a flick for switching the page 210 displayed in the preview area 201 is performed by the user (step S405, YES), the controller 101 performs the following control. That is, the controller 101 selects the switched page 210 as the page 210 to be edited in accordance with the operation such as the flick (step S406). On the other hand, when no operation such as a flick for switching the page 210 displayed in the preview area 201 is performed by the user (step S405, NO), the process returns to step S403.

At step S407, the controller 101 acquires, from the book database, text information indicating the content of a text written in the text area 203 set in the page 210 to be edited. When there are a plurality of text areas 203 set in the page 210 to be edited, at least text information indicating the content of the text written in the text area 203 to be edited is acquired.

At step S408, the controller 101 sets the text edit area 206 at a predetermined position within the edit screen 200 and displays the text information acquired at step S407 in the text edit area 206.

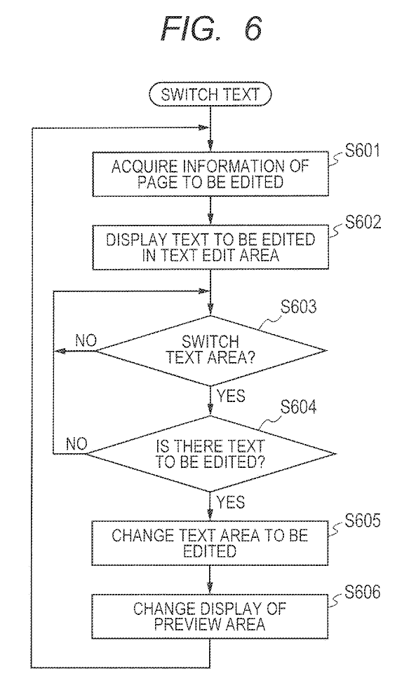

When an operation such as a flick for switching the text area 203 to be edited is performed by the user (step S409, YES), the process returns to step S403. The controller 101 can function as an accepting unit configured to accept a switching operation for switching the text area 203 to be edited. At step S403, the controller 101 provides the mark 207 to the text area 203 to be newly edited. When no operation such as a flick for switching the text area 203 to be edited is performed by the user (step S409, NO), step S410 is entered. Note that switching of the text area 203 will be described later by using FIG. 6.

When entry of a text is performed on the text edit area 206 (step S410, YES), the process returns to step S403. At step S403, based on the content of the text entered in the text edit area 206, the controller 101 displays the text in the text area 203 to be edited. When it is determined that the entry of the text to the text edit area 206 is completed, the controller 101 reflects the content of the text entered in the text edit area 206 to the book database. When there is no entry of a text to the text edit area 206 (step S410, NO), the process returns to step S404. Then, when the end button 208 for closing the book editing is pressed by the user (step S404, YES), the editing of the book 209 ends.

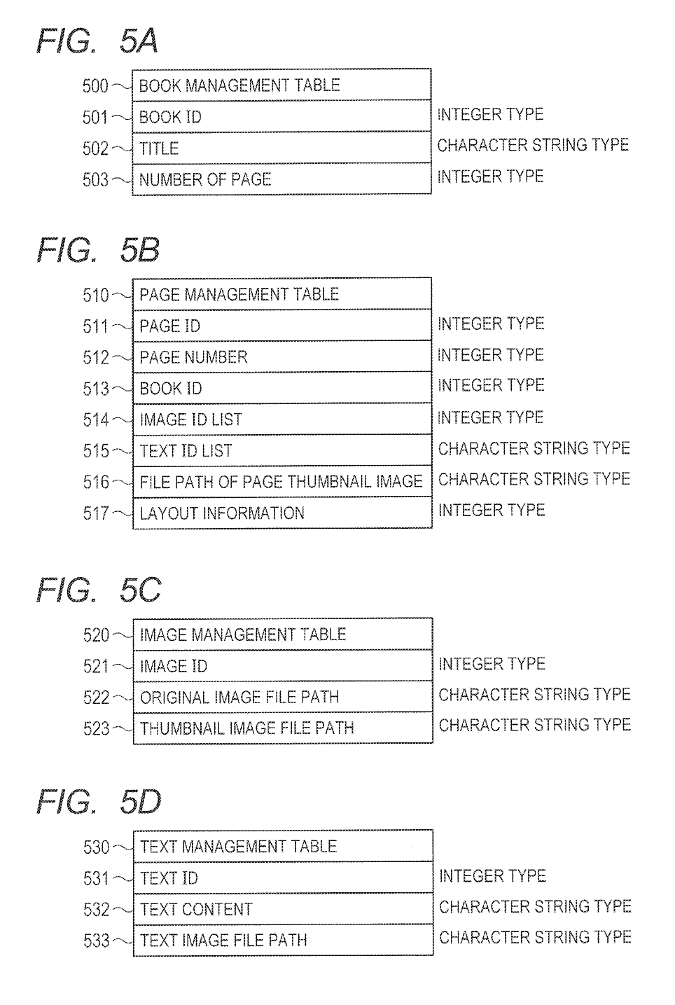

FIG. 5A to FIG. 5D are diagrams illustrating tables used in the information processing apparatus 100 according to the present embodiment. FIG. 5A illustrates a book management table. As illustrated in FIG. 5A, the book management table 500 includes a book ID 501 for uniquely identifying the book 209 on an application program, a title 502 of the book 209 entered by the user, and the number of pages 503 of the book 209. The data type of the book ID 501 and the number of pages 503 is an integer type, and the data type of the title 502 is a character string type.

FIG. 5B illustrates a page management table. As illustrated in FIG. 5B, the page management table 510 includes a page ID 511 for uniquely identifying the page 210 on an application program and a number 512 indicating a page order within the book 209. The page management table 510 further includes a book ID 53 that is an ID or the book 209 to which the page 210 belongs and an image ID list 514 that is an ID list of one or more images arranged in the page 210. The page management table 510 further includes a text ID list 515 that is an ID list of one or more texts arranged in the page 210. The page management table 510 further includes a file path 516 that is a path on a disk of a page thumbnail image that is a thumbnail image of the page 210 displayed in the preview area 201. The page management table 510 further includes layout information 517 of the page 210. The data type of the page ID 511, the page number 512, the book ID 513, the image ID list 514, and the layout information 517 is an integer type, and the data type of the text ID list 515 and the file path 516 the page thumbnail image is a character string type.

FIG. 5C illustrates an image management table. The image management table 520 includes an image ID 521 for uniquely identifying an image on the application program. The image management table 520 further includes an original image file path 522 that is a path on the disk of an image file of an original image of the image used in the book 209. The image management table 520 further includes a thumbnail image file path 523 that is a path on the disk of the image file of the thumbnail image displayed in the preview area 201. The data type of the image ID 521 is an integer type, and the data type of the original image file path 522 and the thumbnail image file path 523 is a character string type.

FIG. 5D illustrates a text management table. The text management table 530 includes a text ID 531 uniquely identifying a text on the application program and a text content 532 that is a content of the text. The text management table 530 further includes a text image file path 533 that is a path on the disk of the image file of the imaged text. The data type of the text ID 531 an integer type, and the data type of the text content 532 and the text image file path 533 is a character string type.

FIG. 6 is a flowchart illustrating the operation of the information processing apparatus 100 according to the present embodiment. FIG. 6 illustrates the operation when switching the text area 203 to be edited.

At step S601, the controller 101 acquires information of the page 210 to be edited. The controller 101 acquires the following information from the page management table 510 with a key of the book ID 513 of the book 209 to be edited and the page number 512 of the page 210 to be edited. That is, the controller 101 acquires the layout information 517, the image ID list 514, and the text ID list 515 from the page management table 510. Based on these pieces of information, the controller 101 then displays a page of the book 209 in the preview area 201 of the edit screen 200. Note that, when the setting of the display magnification is changed by a pinch-in, a pinch-out, or the like, the page of the book 209 is displayed at the changed display magnification in the preview area 201. The controller 101 provides the mark 207 to the text area 203 to be edited. Note that the book ID 513 of the book 209 to be edited is represented by a variable nSBook. Further, the page number 512 of the page 210 to be edited is represented by a variable nSPage. Further, the display magnification is represented by a variable vZoom. Further, the text ID of the text area 203 to be edited is represented by a variable nSText.

At step S602, the content of the text of the text area 203 to be edited is displayed in the text edit area 206. That is, the controller 101 acquires the text content 532 from the text management table 530 with a key of the text ID of the text area 203 to be edited, namely, the variable nSText. The controller 101 then displays the text content 532 acquired from the text management table 530 in the text edit area 206.

When an operation such as a flick for switching the text area 203 to be edited is performed by the user (step S603, YES), step S604 is entered. When no operation for switching the text area 203 to be edited is performed by the user (step S603, NO), step S603 is repeated until an operation for switching the text area 203 to be edited is performed by the user.

At step S604, when having switched the text area 203 to be edited, the controller 101 determines whether or not there is a text to be edited next. That is, the controller 101 searches the text ID of the text area 203 to be edited next with a key of the text ID of the text area 203 which was to be edited before performing the switching operation, namely, the variable nSText. When there is a text III) of the text area 203 to be edited next (step S604, YES), step S605 is entered. There is no text ID of the text area 203 to be edited next (step S604, NO), the process returns to step S603.

At step S605, the text area 203 to be edited is changed. That is, the controller 101 changes the text ID indicating the text area 203 to be edited, namely, the variable nSText from the text ID of the text area 203 which has not been switched to the text ID of the text area 203 which has been switched.

At step S606, the controller 101 changes a display of the preview area 201. More specifically, the controller 101 sets the display magnification of the page of the book 209 displayed in the preview area 201, that is, the variable vZoom to 100% (equal magnification), for example. In other words, the controller 101 sets the display magnification of the page 210 displayed in the preview area 201 to 100% (equal magnification). Note that, as described above, the display magnification of 100% is the default display magnification. The display magnification of 100% corresponds to a display magnification such that the entire page of the book 209 is displayed over the whole preview area 201.

FIG. 2 corresponds to a state where the display magnification is set to 100%. As illustrated in FIG. 2, the display size of a page of the book 209 may be slightly smaller than the size of the preview area 201. Further, the display size in the vertical direction of a page of the book 209 may be the same as the display size in the vertical direction of the preview area 201. Further, the display size in the horizontal direction of a page of the book 209 may be the same as the display size in the horizontal direction of the preview area 201. The aspect ratio of a page of the book 209 and the aspect ratio of the preview area 201 may or may not be the same as each other. When the preview area 201 is horizontally longer than the book 209, a blank space may occur in the left part or the right part of a page with respect to the book 209 of the preview area 201. When the preview area 201 is vertically longer than the book 209, a blank space may occur in the upper part or the under part with respect to a page of the book 209 of the preview area 201. In any cases, any form may be employed as long as the entire page of the book 209 is displayed in the preview area 201 and thereby the user can review which position of the entire page the text area to be newly edited is located. When the page of the book 209 is displayed in the preview area 201 at a display magnification greater than 100% as seen in FIG. 3, setting the display magnification to 100% results in a zoomed-out display of the book 209.

Note that, while the entire page of the book 209 is displayed within the preview area 201 has been described as an example, the display is not limited thereto. In general, since the text area 203 is not arranged in the fringe area of the book 209, the user will not fail to identify which text area 203 is to be edited even when the fringe area of a page of the book 209 is not displayed within the preview area 201. Therefore, when the display magnification of a page of the book 209 is changed at step S606, such a display magnification may be employed that the fringe area of the book 209 is not displayed within the preview area 201.

As discussed above, when a switching operation is accepted in a state where the page 210 is displayed in the preview area 201 at a first display magnification where a part of the page 210 is not displayed in the preview area 201, the controller 101 performs the following control. That is, the controller 101 performs control so as to display the page 210 in the preview area 201 at a second display magnification that is less than the first display magnification. The second display magnification is such a display magnification that the entire page 210 is displayed within the preview area 201, for example. The process then returns to step S601.

As discussed above, when an operation for switching the text area 203 to be edited is performed in a state where the page 210 is displayed in the preview area 201 at the first display magnification that is greater than a predetermined display magnification, the following control is performed. That is, the page 210 is displayed at the second display magnification that is less than the first display magnification. Thus, according to the present embodiment, a user can easily identify which text area 203 is to be edited.

### Other Embodiments

Embodiment (s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, a part of the embodiment described above may be combined as appropriate.

Further, while the case where the mark 207 is Provided to the text area 203 to be edited has been described as yin example in the above embodiment, the present invention is not limited thereto. Further, while the case where the mark 207 with a dashed line is provided has been described as an example in the present embodiment, the present invention is not limited thereto. For example, the text area 203 to be edited may be provided with a different color from that of the text area 203 which is not to be edited. Further, the text area 203 to be edited may be displayed in a blinking manner. That is, the text area 203 to be edited may be displayed in a different manner from the text area 203 which is not to be edited. Thereby, the text area 203 to be edited can be identified.

Further, while the case of determining a layout of the book 209 having a plurality of pages 210 has been described as an example in the above embodiment, the present invention is not limited thereto. For example, the present invention can be applied to a case of determining a layout of a printed material or the like comprising a sheet. In the present specification, a page may include such a single sheet.

Further, while the case where editing by a user is performed on the text area 203, that is, an area where a text is arranged has been described as an example in the above embodiment, the present invention is riot limited thereto. That is, an area to be edited is not limited to an area where a text is arranged. The present invention can be applied when editing is performed on any editable area (object). For example, the present invention can be applied to a case where the object is a figure or the like.

Further, while a case where the page 210 is scrolled when a user operation such as a flick is performed on the preview area 201 has been described as an example in the above embodiment, the present invention is not limited thereto. For example, a scroll bar may be arranged in the edit screen 200, and the page 210 displayed within the preview area 201 may be changed based on a user operation on the scroll bar. Further, a “previous” button and a “next” button may be arranged, and the page 210 to be edited may be changed by a user operation on these buttons. Further, the page 210 to be edited may be changed by a key operation or the like.

Further, while the case where the text area 203 to be edited is switched when a user operation such as a flick is performed on the text edit area 206 has been described as an example in the above embodiment, the present invention is not limited thereto. For example, the text area 203 to be edited may be changed based on an operation on a “previous” button and a “next” button. Further, the text area 203 to be edited may be changed by a key operation or the like.

Further, the case where a display magnification is changed such that the entire page 210 is displayed within the preview area 201 when an operation for switching the text area 203 to be edited is performed while the page 210 is zoomed in has been described as an example in the above embodiment. However, the present invention is not limited thereto. For example, the display magnification may be changed such that the text area 203 to be edited is displayed at least within the preview area 201. With the text area 203 to be edited being displayed at least within the preview area 201, the user can identify which text area 203 is to be edited.

This application claims the benefit of Japanese Patent Application No. 2016-167139, filed Aug. 29, 2016 which is hereby incorporated by reference herein in its entirety.

What is claimed is:

1. An information processing apparatus comprising:
a processor; and
a memory storing a program which, when executed by the processor, causes the information processing apparatus to:
display, on a screen at a first display magnification, a part of an area of a page in which a plurality of objects are arranged;
accept an operation for changing an object to be selected among the plurality of objects when the part of the area of the page is displayed in the screen at the first display magnification; and
display the entire page including the changed object to be selected at a second display magnification that is less than the first display magnification when the object to be selected is changed.

2. The information processing apparatus according to claim 1, wherein an operation for setting the first display magnification is further accepted.

3. The information processing apparatus according to claim 1, wherein the second display magnification is 100%.

4. The information processing apparatus according to claim 1, wherein the object to be selected is displayed in a different manner from another object.

5. The information processing apparatus according to claim 1 further comprising a touch panel including a display device which displays the screen and an input device to which the change operation is input,
wherein the change operation is a flick operation on the object.

6. The information processing apparatus according to claim 1, wherein the object is a text area in which a text is entered.

7. The information processing apparatus according to claim 6, wherein an image area in which an image is displayed is further arranged in the page.

8. An information processing method comprising steps of:
displaying, on a screen at a first display magnification, a part of an area of a page in which a plurality of objects are arranged;
accepting an operation for changing an object to be selected among the plurality of objects, when the part of the area of the page is displayed at the first display magnification; and
displaying the entire page including the changed object to be selected at a second display magnification that is less than the first display magnification when the object to be selected is changed.

9. A non-transitory computer-readable storage medium storing a program that, when executed by a processor, cause the processor to perform operations comprising:
displaying, on a screen at a first display magnification, a part of an area of a page in which a plurality of objects are arranged;
accepting an operation for changing an object to be selected among the plurality of objects when the part of the area of the page is displayed at the first display magnification; and
displaying the entire page including the changed object to be selected at a second display magnification that is less than the first display magnification when the object to be selected is changed.
